(19) United States
(12) Patent Application Publication
(10) Pub. No.: US 2006/0262818 A1
(43) Pub. Date: Nov. 23, 2006

(54) Microcontroller based thermoelectric cooler controller

(75) Inventors: Dev E. Kumar, San Mateo, CA (US); James Douma, Monrovia, CA (US); Lucy G. Hosking, Santa Cruz, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation

(21) Appl. No.: 11/119,134

(22) Filed: Apr. 29, 2005

(51) Int. Cl. H01S 3/04

(52) U.S. Cl. 372/34

(57) ABSTRACT

Controlling a thermo electric cooler (TEC) in a transceiver using a microcontroller. The microcontroller is used to control functionality in addition to the TEC control functionality. Specifically, the TEC is controlled using a control algorithm in the microcontroller. The microcontroller sends signals to a switching device that controls current through TEC.

### BACKGROUND OF THE INVENTION

1. The Field of the Invention

The invention generally relates to controlling thermoelectric coolers (TEC) in fiber-optic transceivers. More specifically, the invention relates to using a microcontroller in a TEC controller.

2. Description of the Related Art

The need for advanced speed in network communications has led to the installation of fiber-optic networks. Fiber-optic networks communicate data across fiber-optic cables using light signals. The light signals are generally generated by a light emitting diode (LED) or laser diode. An electrical signal is applied to the LED or laser diode which converts the electrical signal to an optical signal. In the receive path, optical signals are received by a photosensitive device that converts the light signals into an electrical signal for use by a host device in which the photosensitive device is disposed. Typically, a host device will have both a transmitting portion that includes an LED or laser diode and a receiving portion that includes a photosensitive device such as a photodiode. The transmitting portion and receiving portion are typically combined in a device known as a transceiver.

To accomplish quick, efficient and high-speed data communications using fiber-optic cabling, there is a need for regulated operating conditions in which the transceiver operates. Particularly, changes in temperature may effect the output wavelength of an LED or laser diode. One way of controlling temperature on an LED or laser diode is by using a thermoelectric cooler (TEC).

Generally, a TEC is a device where current flow through the device will heat one side of the device while cooling the other side of the device. The side that is heated and the side that is cooled are controlled by the direction of the current flow. Thus, current flow in one direction will heat a first side while the same first side will be cooled when the current flow is reversed. Thus, by varying the current direction, a TEC connected to a laser or photodiode may be used to either heat or cool the laser or LED to maintain a constant operating temperature.

A TEC is generally controlled using an analog PID controller that is connected to a switching circuit. Often, the switching circuit provides circuitry for generating current flow in the TEC in both directions. This may be accomplished by using for example an H bridge or push pull amplifier. The analog controller typically makes use of analog amplifiers and resistor, capacitor and inductor networks. The analog amplifiers may be embodied in a specialized controller chip specifically designed and manufactured for use in TEC controllers. Temperature settings are accomplished by connecting external components, such as resistors, to the specialized controller chips.

Various optimizations for transceivers are desirable. For example, smaller components in digital applications and the constant miniaturizing of components, it is also desirable that the transceiver size be minimized. However, the use of external components runs counter to optimizations designed to minimize the size of the transceiver. It is therefore desirable to minimize the number of components used in a TEC controller for purposes of miniaturization.

It is also desirable that the transceiver minimize power use. Analog controllers and the external components used with the analog controllers require a certain amount of power and thus correspondingly generate some amount of heat. It is therefore desirable to limit the number of components used in TEC controllers to conserve power. This is especially true in optical transceivers because various standards and multi source agreements (MSAs) dictate the amount of total power that may be consumed by an optical transceiver.

Another challenge that arises in optical circuits is the propensity of laser characteristics to change over time. That is, the longer a laser is in service, the more the laser's characteristics will change from those possessed by the laser when it was originally manufactured. For example, the output optical power of a laser can be graphed against the current running through the laser. Current running through the laser also contributes to the heating of the laser. When a transceiver is first fabricated, many components used with the laser such as a laser driver and the TEC circuit are designed based on the output power to current characteristics existing at the time the transceiver is fabricated. However, as the transceiver ages, the amount of current needed to power a laser to produce a specific optical power output will also change. Additionally, regulating temperature variations of an aged laser may require a different control algorithm than the control algorithm used on a new laser. However, most analog TEC controllers are only able to implement a single control algorithm for steady state operation. Therefore, as a transceiver ages the control of the analog controller may not be optimized for optimal cooling of the laser.

Yet another challenge that arises in the control of TEC controllers and the temperature of lasers is the difference in control needed for a laser when the laser is first turned on compared to the control needed for a laser under steady state conditions. When a transceiver is first powered on, the laser may be in a much cooler state than is desired for optimal operation. It may therefore be desirable to ramp the temperature up at a rapid rate so as to quickly allow the laser to reach a steady state operating temperature. However, this requires a specialized TEC controller with advanced functionality. Additionally, to utilize this advanced functionality additional components, such as additional resistors, capacitors and inductors, are required thus increasing both size and power consumption.

### BRIEF SUMMARY OF THE INVENTION

One embodiment of the invention includes an apparatus for controlling a TEC. The apparatus includes a switch device. The switch device is designed to supply current to the TEC. A microcontroller is connected to the switch device. The microcontroller is configured to control the switch device to allow current to flow through the TEC. The microcontroller is also configured to control other functionality in a transceiver in addition to the TEC control. Advantageously, this allows a microcontroller that may already be designed for other functionality in a transceiver to be utilized for TEC control thus conserving power resources and reducing component count in the transceiver. Additionally, using a microcontroller allows for more flexible control of the TEC to be accomplished.

An embodiment of the invention may be implemented as a transceiver for use in fiber-optic communications. The transceiver includes a light generating device such as a laser diode or light emitting diode. The light generating device is configured to convert electrical signals to light (optical) signals for transmission on a fiber-optic network. A TEC is connected to the light generating device. The TEC is configured to regulate the temperature of the light generating device. A switch is connected to the TEC. The switch in configured to switch current through the TEC. The microcontroller is connected to the switch. The microcontroller is configured to control the switch. The microcontroller is also configured to control functionality of at least one other function or device in the transceiver.

Embodiments may also be implemented as methods for controlling the temperature components on a transceiver. One exemplary embodiment includes an act of sensing temperature of a device in the transceiver. An indication of temperature of the device is provided to a microcontroller. At the microcontroller, a control algorithm is performed using the indication of temperature as a feedback parameter. The microcontroller also performs other functionality in the transceiver. A control signal is sent to a switching device. The control signal is dependent on the results of the control algorithm. At the switching device, current is switched to a TEC. This allows the thermal response of the TEC to the current to be used to regulate the temperature of the device in the transceiver.

These and other advantages and features of the present invention will become more fully apparent from the following description and appended claims, or may be learned by the practice of the invention as set forth hereinafter.

### BRIEF DESCRIPTION OF THE SEVERAL VIEWS OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a topology including two hosts communicating through a fiber-optic connection where various embodiments of the invention may be implemented;

FIG. 2 illustrates one embodiment where a microcontroller is used as a controller for a switch used to control a TEC for regulating temperature of a light generating device; and

FIG. 3 illustrates a switch embodied as an H-bridge such that current to a TEC can be switched in two directions to change the heating and cooling characteristics of the TEC.

### DETAILED DESCRIPTION OF THE INVENTION

As described previously herein a thermoelectric cooler (TEC) is used to regulate the temperature of a laser or light emitting diode (LED) in an optical transceiver. A TEC controller is used to control the operation of the TEC. The TEC controller is typically connected to a switch device where the switch device is used to switch current through the TEC. Various embodiments of the present invention make use of an existing microcontroller commonly employed in a transceiver device as the TEC controller. This allows for the implementation of a control that is flexible depending on the operating conditions in which the transceiver is being operated (e.g. start up vs. steady state). Additionally as a transceiver ages, a microcontroller based control can take into account changes in laser characteristics when controlling the TEC.

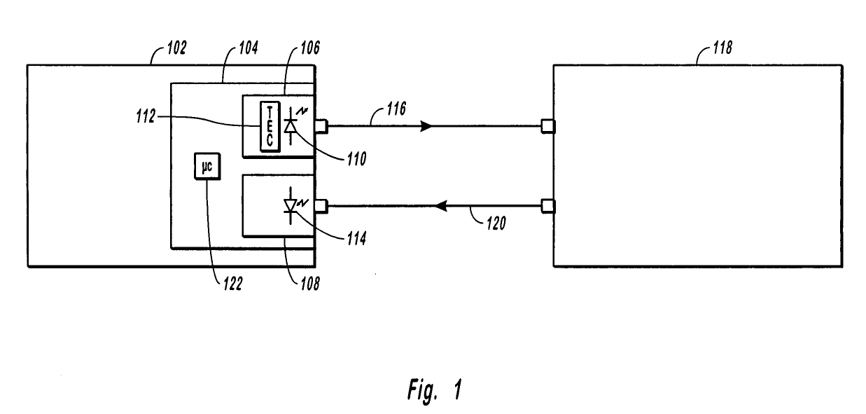

Referring now FIG. 1, a topology where embodiments the invention may be used is shown. FIG. 1 illustrates an host 102 that includes a transceiver 104. The transceiver generally includes a transmitting optical subassembly (TOSA) 106 and a receiver optical subassembly (ROSA) 108. The TOSA 106 includes a light generating device 110 such as an LED or laser diode. The light generating device 110 is typically thermally connected to a TEC 112 where the TEC 112 is used to control the operating temperature of the light generating device 110. The ROSA 108 includes a light-sensitive device 114 such as in this example a photodiode.

Illustratively, data from the host 102 is sent to the transceiver 104 where the data is converted from an electrical signal to an optical signal and transmitted on a transmitting path 116. The transmitting path 116 is typically an optical fiber. The data is transmitted from the first host 102 to a second host 118 that also includes, although not shown here, a transceiver for sending and receiving optical data. In the return path the second host 118 sends a signal on a receiving path 120 where the data from the second host 118 is received by the ROSA 108 in the transceiver 104. The ROSA includes the photosensitive device 114 that converts the optical signal on the receive path 120 to an electrical signal. The electrical signal may then be fed to the host device 102 for use by the host device 102.

The transceiver 104 also includes a microcontroller 122. Ordinarily, the microcontroller controls various functions on the transceiver 104. One such function may include monitoring environmental characteristics such as temperature and power supply voltage. Another function may include monitoring transmit power, laser bias and received optical power. Another function may include controlling laser bias, photo detector bias and laser modulation. Another function may include communicating with the host device 102.

Thus in one embodiment invention, the microcontroller 122 may be used to control a TEC controller (not shown) for controlling or regulating heat pumping characteristics of the TEC 112 in addition to the other functionality of the microcontroller. For example, the microcontroller may implement a PID control algorithm for controlling the temperature of the light generating device 110.

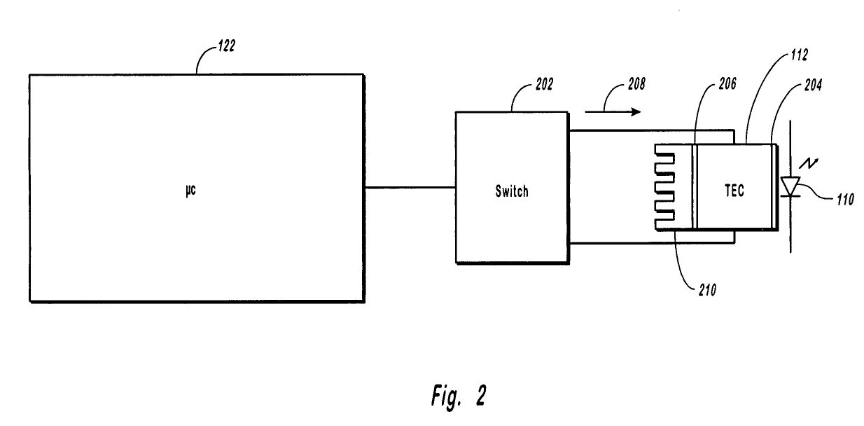

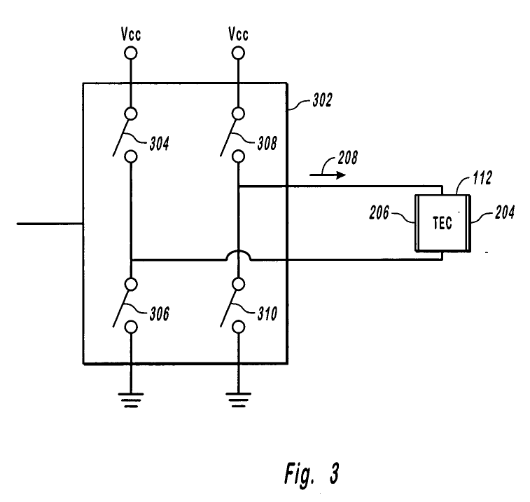

A temperature sensor or thermocouple connected to the light generating device 110 may be used to collect an indication of temperature of the light generating device 110, or any other heat generating device in the transceiver 104. The indication of temperature, which may be for example, an analog voltage or a digital signal from an analog to digital converter, is provided to the microcontroller as feedback for the PID control. The PID control causes the microcontroller to send a control signal that is dependant on the control algorithm, to a switching device (explained in more detail below in conjunction with the description of FIGS. 2 and 3). The switching device causes a current to be delivered to the TEC 112 such that the thermal response of the TEC to the current can be used to regulate the temperature of the light generating device 110.

Referring now to FIG. 2 an exemplary embodiment illustrating a microprocessor 122 controlling the TEC 112 for regulating the temperature of the light generating device 110 is shown. Typically the microcontroller 122 is capable of outputting low power digital signals at pins integrated into the microcontroller 122. These low power digital signals may be used to control a switch 202 that is capable of switching higher power currents that are sufficient to drive in the TEC 112. By way of example and not by limitation, the digital switch 202 may be capable of switching currents in the range of about 500 mA.

Referring once again to FIG. 2, the operation of the TEC 112 is illustrated. The TEC 112 includes two sides, a first side 204 and a second side 206. Depending on the direction of current flow through the TEC 112, one of the two sides will produce heat while the other side is cooled. Thus if current flows in a first direction 208, the first side 204 is cooled while the second side 206 is heated.

In one embodiment, a heatsink 210 may be attached to the second side 206. The heatsink 210 may be mounted externally on a transceiver such as the transceiver 102 shown in FIG. 1. This helps to dissipate heat generated by the light generating device 110 through the TEC 112 to the heatsink 210. The heat can be dissipated into the surrounding air for maintaining an appropriate operating temperature of the light generating device 110. A feedback loop may provide an indication of temperature of the light generating device 110 to the microcontroller 122. This feedback is used by the PID controller to regulate the current through the TEC 112 for regulating the temperature of the light generating device 110. Accordingly, in addition to controlling one or more functions of the transceiver 104, the microcontroller 122 also controls the operation of the TEC 112.

FIG. 3 shows an H bridge switch 302. The H bridge switch 302 is connected to the TEC 112. Using an H bridge switch such as of the switch 302 shown in FIG. 3, not only can the current flow be controlled, but also the direction of current flow can be controlled. The H bridge switch 302 contains four internal switches 304, 306, 308 and 310. By controlling which switches are closed at any given time, the direction of current flow can be controlled. For example, when switch 304 and switch 310 are closed, current flows in a first direction 208. This causes a first side of the TEC 204 to be cooled while a second side of the TEC 206 is heated. When switches 304 and a 310 are open and switches 308 and 306 are closed, a current opposite in direction to the first current 208 is generated through the TEC 112. This causes the first side of the TEC 204 to be heated while the second side of the TEC 206 is cooled. Thus, using an H bridge switch 302, a light generating device can be either heated or cooled as needed. Accordingly, in addition to controlling one or more functions of the transceiver 104, the microcontroller 122 also controls the operation of the TEC 112. The switches in a FIGS. 3, 304, 306, 308, and 310 may be for example, transistors.

The H-bridge switch 302 may generally be described as an amplifier circuit. Other amplifiers circuits may also be used for switching current to the TEC 206. For example, using the digital control of the microprocessor, class D amplifiers are particularly well suited to embodiments of the present invention. A class D amplifier is generally a pulse width modulated (PWM) amplifier. Pulse width modulated amplifiers vary the amount of time that a square wave signal is high compared to the amount of time that the signal is low. Thus, in one embodiment, the class D amplifier causes the side of the TEC that is connected to the light generating device to cool when the square wave signal is high and to heat or turn off when the square wave signal is low. Various other types of amplifiers may also be used.

The feedback control implemented by the microcontroller may be very flexible due to the nature of modern microcontrollers. For example, the feedback control may include a parameter defining the age of a light generating device. An age value may be stored in a memory where that age value is constantly updated to reflect the amount of time that a light generating device has been in use. The feedback control may vary the amount of current delivered to a TEC controller based on the age value. Thus, the output of the light generating device may be controlled by varying temperature of the light generating device according the age of the light generating device.

The feedback control may also include a parameter that varies according to how long a transceiver has been operational. For example, if a transceiver is first started after an extended period of inactivity, it may be desirable to quickly heat the light generating device to a desired operating temperature by designing for a transfer function response of the feedback control that allows for quick heating. Once the light generating device is at a particular operating temperature, the feedback control may have a different transfer function response that allows for more gradual temperature changes in the light generating device.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An apparatus for controlling a TEC comprising:
a switch device, the switch device adapted supply current to a TEC;
a microcontroller coupled to the switch device, the microcontroller configured to control the switch device to allow current flow through a TEC and to control other transceiver module functionality in an optical transceiver.

2. The apparatus of claim 1 wherein the switch device is adapted to switch current in a first and a second direction for switching the sides of a TEC that are heated and cooled.

3. The apparatus of claim 2 wherein the switch device comprises an H bridge.

4. The apparatus in claim 1 wherein the switch device is a class D amplifier.

5. The apparatus of claim 1 wherein the microcontroller is configured to implement a different feedback control at start up of a transceiver than during a steady state control.

6. The apparatus of claim 1 wherein the microcontroller is configured to implement a feedback control that uses a parameter defining the age of a light generating device.

7. A transceiver for use in fiber-optic communications the transceiver comprising:
a light generating device configured to convert electrical signals to optical signals for transmission on a fiber-optic network;
a TEC coupled to the light generating device and configured to regulate the temperature of the light generating device;
a switch device coupled to the TEC, the switch device configured to switch current through the TEC; and
a microcontroller coupled to the switch device wherein the microcontroller is configured to control the switch device, the microcontroller also being configured to control functionality of at least one other function or device in the transceiver.

8. The transceiver of claim 7, wherein the light generating device is an LED.

9. The transceiver of claim 7, wherein the light generating device is a laser diode.

10. The transceiver of claim 7, further comprising a heatsink coupled to the TEC.

11. A method of controlling temperature of components on a transceiver, the method comprising:
sensing temperature of a device in the transceiver;
providing an indication of temperature of the device to a microcontroller;
at the microcontroller performing a control algorithm using the indication of temperature as a feedback parameter, wherein the microcontroller performs other functionality in the transceiver;
sending a control signal to a switching device, the control signal being dependant on the results of performing a control algorithm; and
at the switching device, switching a current to a TEC such that the thermal response of the TEC to the current can be used to regulate the temperature of the device in the transceiver.

12. The method of claim 11, wherein switching a current to a TEC causes a first side of the TEC connected to the device in the transceiver to be cooled.

13. The method of claim 11, wherein switching a current to a TEC causes a first side of the TEC connected to the device in the transceiver to be heated.

14. The method of claim 11, wherein switching a current to a TEC comprises switching a pulse width modulated current to the TEC such that when the pulse width modulated signal is high, one side of the TEC is heated and when the pulse width modulated signal is low, the one side of the TEC is cooled.
